(19) United States
(12) Patent Application Publication
(10) Pub. No.: US 2003/0112506 A1
(43) Pub. Date: Jun. 19, 2003

(54) Method and apparatus for viewing a scene

(76) Inventor: Kori Cromer, Somerville, MA (US)

Correspondence Address: Robert K. Tendler, 65 Atlantic Avenue, Boston, MA, 02110, US

(21) Appl. No.: 10/022,675

(22) Filed: Dec. 18, 2001

(51) Int. Cl. G02C 1/00; G02B 23/00

(52) U.S. Cl. 359/407; 359/409; 351/158

(57) ABSTRACT

A method and apparatus for viewing sporting events and the like from a distance includes the use of flip-down binoculars, in which the binoculars are mounted to eyeglass frames with the binoculars being wearable by a spectator. The binoculars are flipped down so as to permit close-in viewing of the scene. In one embodiment the binoculars are embedded in lenses within the eyeglass frame, in which the binoculars are hingedly attached to the eyeglass frame at the nose bridge. The binoculars include focusing apparatus that may be manipulated by the individual so as to correct for each of the individual's eyes, with the binoculars being set to focus at infinity. The entire binoculars structure occupies only a portion of the lens area of the glasses, extending fore and aft of the lens area by only a modest amount, thus making the system compact, lightweight and easily manipulated.

### FIELD OF THE INVENTION

This invention relates to remote viewing of events and more particularly to flip-down binoculars carried on traditional eyeglass frames.

### BACKGROUND OF THE INVENTION

When viewing athletic events, opera or the like, it is usual that one wishes to view the entire scene so that one can get an appreciation of what is going on. This requires an exceptionally large angle of view as would be occasioned by normal sight.

For instance, in a baseball game, one likes to see the position of the outfielders as well as the pitcher and the catcher, in addition to being able to view the batter and the infielders, all at the same time. The normal eye is capable of doing so but is incapable of zooming in on whatever activity is of interest to the person viewing the scene.

In the past, cumbersome binoculars have been utilized, as well as opera glasses, to be able to zoom in on a particular portion of the scene. However, the cumbersome nature of the binoculars is such that it is a separate item that is carried by the individual and is in general heavy and not easily made available to the individual for use.

In the past there exist a number of flip-down lenses used for protection against the sun. However, these lenses are optically neutral in the sense that they perform no magnification function. In point of fact, when the surfaces of these flip-down sunglasses are not plate-glass uniform, they distort the scene and therefore are not intended for use in any way to magnify that which the individual is viewing.

In the medical field, there exist a number of binocular devices for magnifying at a short range that which a surgeon, for instance, is looking at. In any event these devices are not focused at infinity and in general, can include barrels carrying the optics which are 3-4 inches in length. The length of the barrels and the optics therein are to permit the doctor to be able to see at close hand those objects that are no more than a couple of feet away, at most. As a result, whether flip down or not, these optical devices are no way suitable for the viewing of events at infinity, e.g., distances that exceed normal ranges at which focusing is needed. For instance, those events that take place more than tens of feet away are viewed as being at infinity, at least as far as the optics are concerned.

Thus as can be seen, it is only with heavy, cumbersome and separate binoculars that sporting events and the like are viewed for close ups. There is no convenient way of carrying the binoculars, other than by putting them in a binocular case and withdrawing them manually and putting them up to one's eyes.

Moreover, the optics within the binoculars dictate the size of the binoculars, which in general have resulted in distances from the eyepiece to the final lens on the order of 5-7 inches. Thus due to their weight and due to the focal lengths involved in the optics, they are not suitable in general for being mounted to headgear, much less on eyeglass frames. Those optical devices which are utilized in surgery are likewise not suitable for viewing of sports or athletics events at a distance because their purpose is to magnify objects which are close by, namely within several feet.

### SUMMARY OF THE INVENTION

In order provide assistance for the individual in order to be able to view events at a distance, in the subject invention, a lightweight optics system is embedded within the lens areas of an eyeglass frame, with the frame surrounding the lens areas being hinged on the earpieces at the bridge of the eyeglass frame so that it may be flipped up in one embodiment.

The optics are such that they straddle the lens area fore and aft and, in one embodiment, are adjustable in terms of focus through the rotation of a threaded cylinder relative to a fixed cylinder making up a binocular tube.

The optics are such that under normal conditions with the eyeglass frame flipped down, the optical apparatus is at the appropriate position vis a vis the eye, such that only minor adjustments are necessary in the optics to bring distant objects into focus and magnify them. In one embodiment, a 3× magnification is envisaged.

Note that the focal plane of the optical apparatus carried in the eyeglass frame is such that its focal plane is coincident with the focal plane established by the lenses of the eyes so that objects at a distance will become magnified and clear.

With the binoculars embedded in eyeglass frames which are flipped up with respect to the earpieces, it will be appreciated that this is an exceedingly convenient way for the magnification optics to be stored when not in use, giving the individual full view of the entire scene when the frame portions carrying the binoculars are flipped up. A quick motion of the hand and wrist moves the flipped-up optics into position for zooming in on the action, with the binoculars embedded in the eyeglass frames at the lens areas. Note that the entire eyeglass structure is both lightweight and minimal in longitudinal distance or thickness so that the flip up structure and eyeglass frame plus ear contacting portions can be easily carried on one's head and flipped down for appropriate viewing.

The result is that a convenient method for viewing events is provided in which cumbersome apparatus need not be separately carried. Rather binoculars are carried on an eyeglass frame, with the optics thereof focused at infinity.

In summary, a method and apparatus for viewing sporting events and the like from a distance includes the use of flip-down binoculars, in which the binoculars are mounted to eyeglass frames with the binoculars being wearable by a spectator. The binoculars are flipped down so as to permit close-in viewing of the scene. In one embodiment the binoculars are embedded in lenses within the eyeglass frame, in which the binoculars are hingedly attached to the eyeglass frame at the nose bridge. The binoculars include focusing apparatus that may be manipulated by the individual so as to correct for each of the individual's eyes, with the binoculars being set to focus at infinity. The entire binoculars structure occupies only a portion of the lens area of the glasses, extending fore and aft of the lens area by only a modest amount, thus making the system compact, lightweight and easily manipulated.

### BRIEF DESCRIPTION OF THE DRAWINGS

These and other features of the subject invention will be better understood in connection with the Detailed Description in conjunction with the Drawings, of which:

FIG. 1 is a diagrammatic representation of a view from a stadium seat from an individual looking at a baseball game prior to flipping down the binoculars on his eyeframes;

FIG. 2 is a diagrammatic representation of the scene of FIG. 1, indicating zooming in on the action at third base, with the individual having flipped down his binoculars;

FIG. 3 is diagrammatic representation of the flipped up position of the binoculars illustrating embedding of the binoculars in the lens area of the eyeglass frame;

FIG. 4 is a diagrammatic representation of the binoculars in place having been flipped down, with the binoculars positioned adjacent to the eyes to permit long-distance viewing;

FIG. 5 is a perspective view of the binoculars of FIG. 4, indicating the adjustment rings on each of the binocular elements;

FIG. 6 is a diagrammatic representation of the binoculars of FIG. 5 in a flipped up position, having been hinged to the nose bridge of the eyeglass frame;

FIG. 7 is a back perspective view of the flipped up binoculars of FIG. 4;

FIG. 8 is a top view of the binoculars of FIG. 4, illustrated in flipped up position;

FIG. 9 is front view of the binoculars of FIG. 4;

FIG. 10 is a top view of the binoculars of FIG. 4 in a flipped down position; and, FIG. 11 is a side view of the binoculars of FIG. 4 in flipped up position.

### DETAILED DESCRIPTION

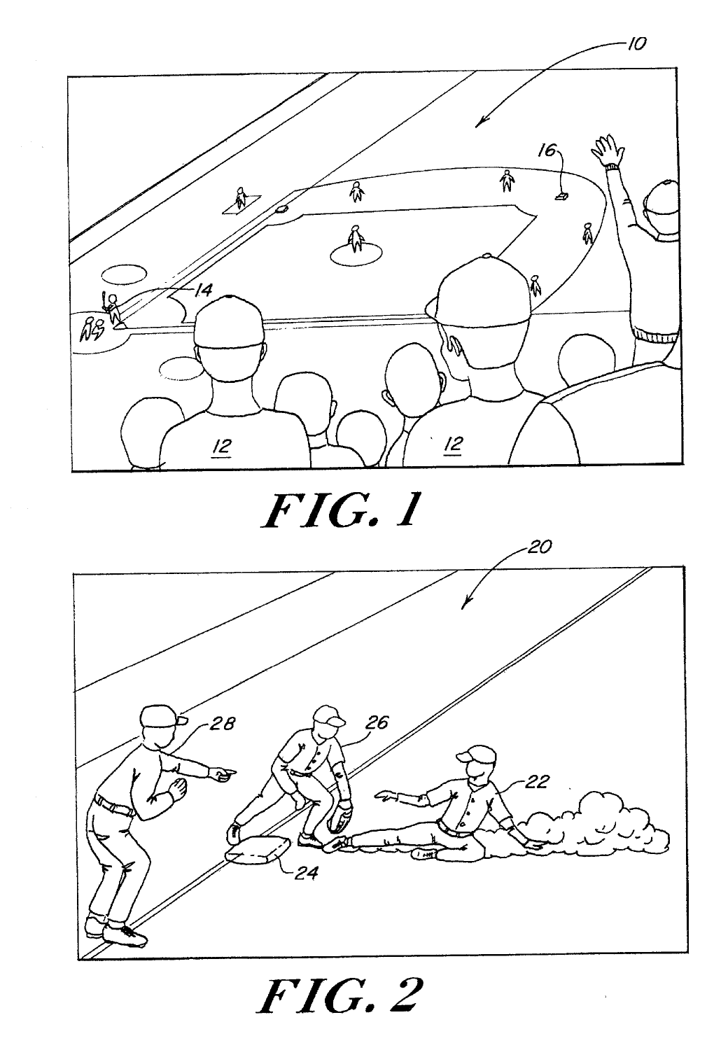

Referring now to FIG. 1, a scene 10 in the illustrated embodiment includes a baseball field with players thereon, with the field being viewed by spectators 12 from a position in the stands. It will be appreciated that the view of spectators 12 is wide angle and encompasses not only a batter 14 to the left-hand side of the field of view but also second base 16 to the right-hand side. It is this view that is normally viewed by the spectators during the game.

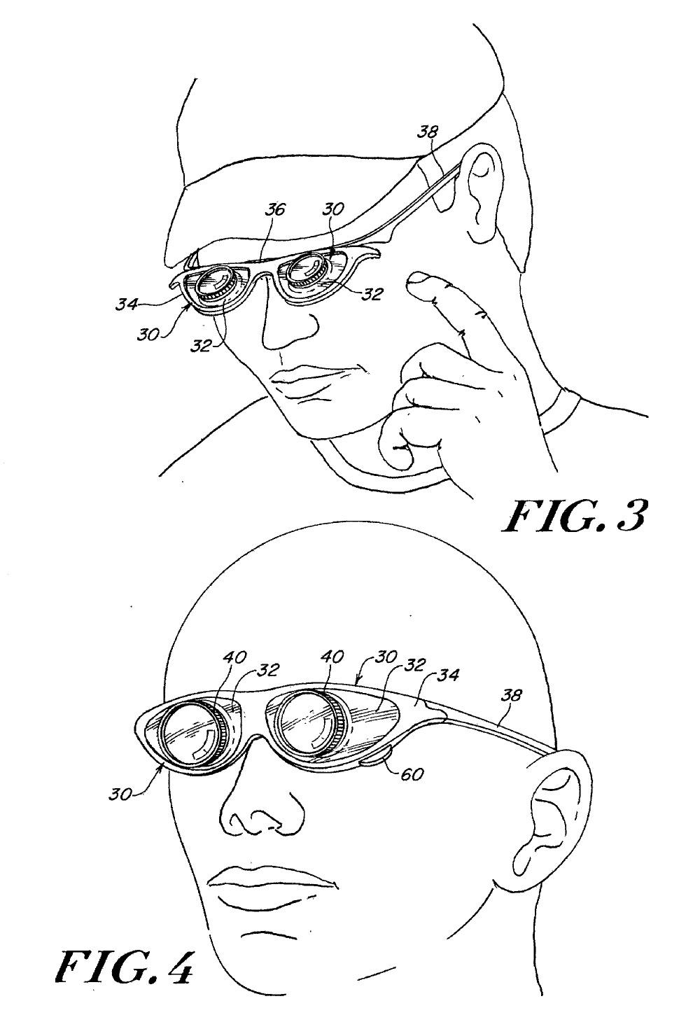

Referring now to FIG. 2, with the subject binoculars in the flipped down position, the view is as illustrated at 20, three times magnified, showing a player 22 sliding into third base 24, with third baseman 26 attempting to tag out player 22, and with third base coach 28 at the scene. It will be appreciated that this is the type of scene that could be viewed by binoculars that are separately carried by the spectator; but in the subject case are worn by the spectator, as illustrated in FIG. 3.

Referring to FIG. 3, binoculars 30 are embedded in lens areas 32 within eyeglass frame 34, with eyeglass frame 34 hingedly attached at 36 to earpiece frame 38, such that as illustrated. When the binoculars are in the flipped up position, they are hinged to earpiece frame 38.

Referring to FIGS. 4 and 5, it will be seen that the binoculars 30 in FIG. 3 had been flipped down over the individual's eyes such that eyeglass frame 34 comes to rest against earpiece frame 38, with the binoculars supported by the bridge of the nose.

It will be seen that while the binoculars are nominally focused at infinity, knurled rings 40 are provided for further adjustment of the binoculars to accommodate the individual eyes of the spectator as well as any disparity between the focal plane as defined by the binoculars and that of the eyes of the spectator. This adjustment can accommodate different spacings between the individual eyepieces of the binoculars and respective eyes, since as lens areas will be spaced from the individual's eyes by varying amounts depending on the fit of the eyeglass frames.

In FIG. 5 it can be seen that the earpiece frame extends around the front of the individual, as illustrated by dotted line 42, with the hinge of frame 34 to frame 38 being at the nose bridge as shown at dotted outline 44.

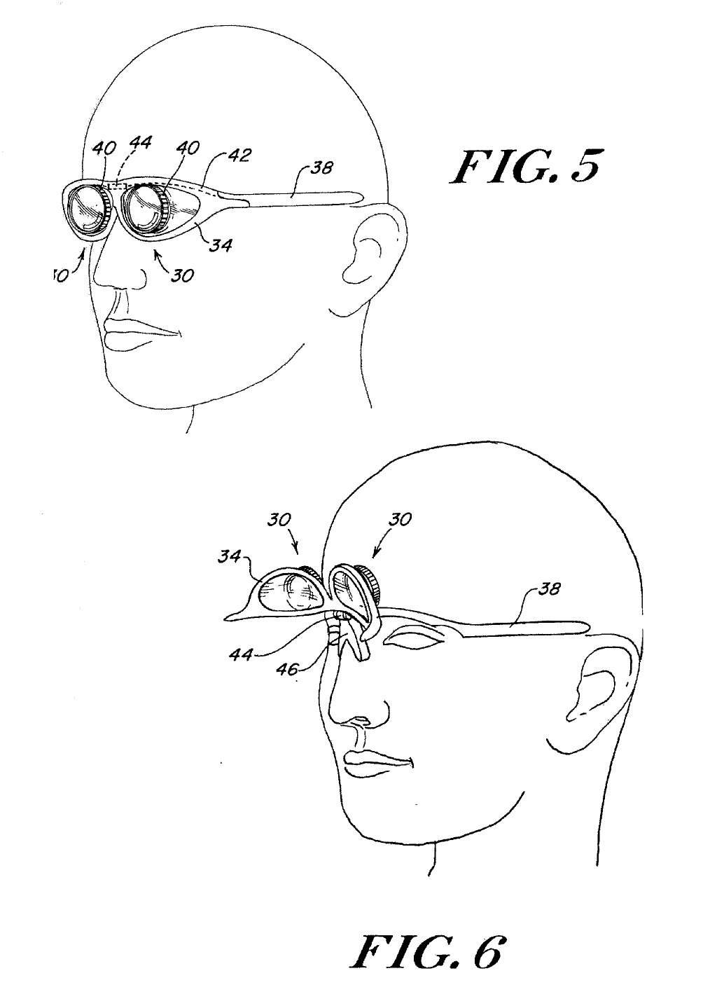

Referring to FIG. 6, it can be seen that hinge 44 is attached to a nose bridge 46, which is integral to earpiece 38, such that the binoculars can be flipped up as illustrated.

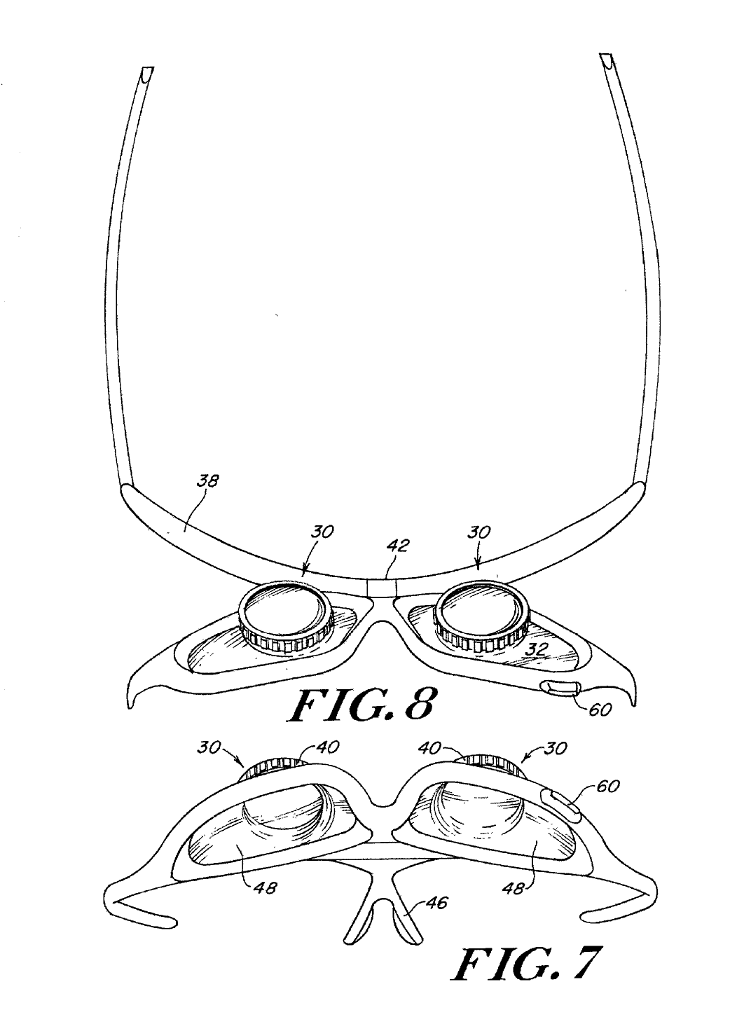

Referring to FIG. 7, it can be seen from a back view that the binoculars 30, in one embodiment are embedded in lenses or other supporting films 48, with the front to back distance between the front of the binoculars and plane defined by lens 48 is, in one embodiment, no more than an inch.

Referring to FIG. 8, a top view of the subject invention includes the binoculars 30 hinged at 44 to earpiece frame 38, with this view clearly showing that the left and right earpieces are joined through a central member, to which is attached the aforementioned nose bridge.

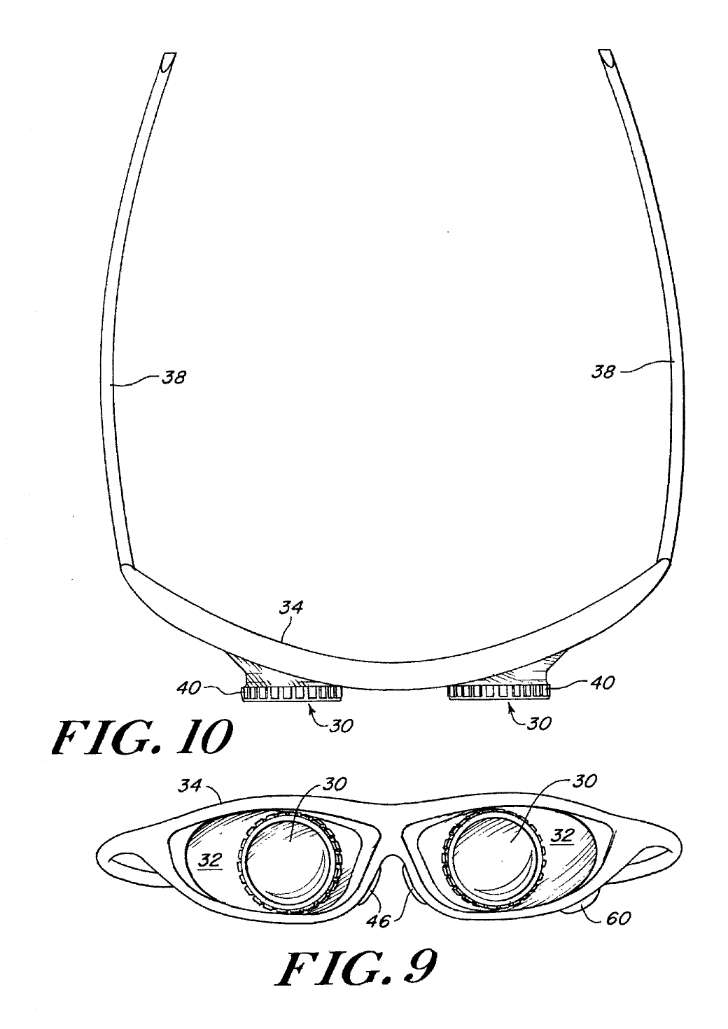

Referring now to FIG. 9, a front view of the subject invention is shown in which binoculars 30 are positioned adjacent nose bridge 46 so as to be in direct alignment with the eyes of the individual when the eyeglasses are in place. Here it can be seen that the lens area 32 into which the binoculars are embedded in one embodiment, may be either clear or opaque, with the clear or transparent version allowing the individual to look to either side without experiencing the magnification of the binoculars.

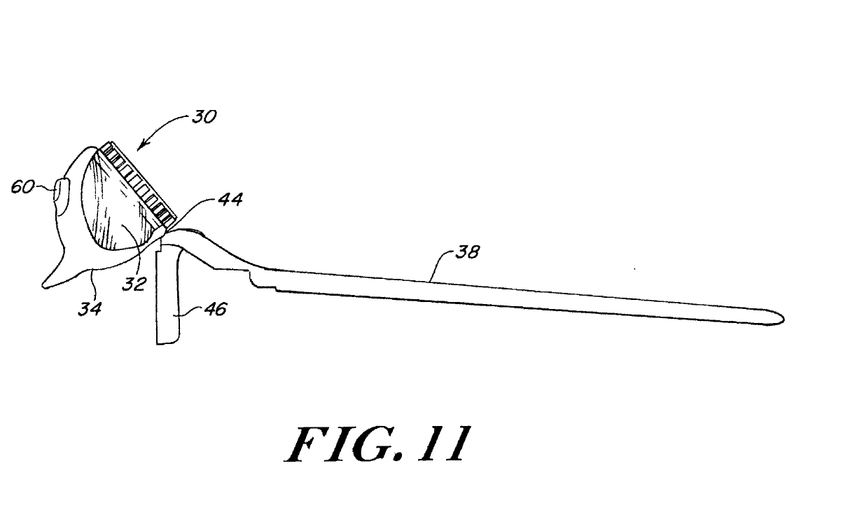

Referring to FIG. 10, a top view is shown in which binoculars 30 are in the flipped down position with respect to earpiece frames 38, whereas in FIG. 11, a side view is illustrated in which the binoculars in flipped up position are shown hinged at 44 to earpiece frame 38 at nose bridge 46.

Note in FIGS. 4, 7, 8 and 9 a flip up tab 60 is provided on frame 34 so as to permit easy flip up and flip down of the binoculars.

What will be appreciated is that in the subject system a head-carried set of binoculars is Farm provided hingedly attached to an eyeglass frame, in one embodiment at the nose bridge, which permits a spectator of an event to easily view a wide angle scene with the binoculars in the flipped up position and to zero in on the action with the binoculars in the flip down position. The convenience associated with light head-mounted flip up binoculars, focused at infinity, is such that one need not carry separate binoculars in order to be able to obtain the close up action that is desired.

Having now described a few embodiments of the invention, and some modifications and variations thereto, it should be apparent to those skilled in the art that the foregoing is merely illustrative and not limiting, having been presented by the way of example only. Numerous modifications and other embodiments are within the scope of one of ordinary skill in the art and are contemplated as falling within the scope of the invention as limited only by the appended claims and equivalents thereto.

What is claimed is:

1. A method for an individual viewing events at a distance comprising the steps of:
mounting binoculars on flip-up eyeglass frames; and,
flipping down the binoculars carried by the eyeglass frames such that the binoculars are positioned adjacent the eyes of the individual to provide a predetermined magnification of the scene occupied by the event, whereby head-carried binoculars may be selectively used to zoom in on a portion of the scene.

2. The method of claim 1, wherein the binoculars are focused at infinity.

3. The method of claim 2, wherein the binoculars include manual focusing adjustment apparatus and further including the step of focusing the binoculars when in the flipped down position.

4. Apparatus for an individual viewing events at a distance from the scene in which the events occur, comprising:
eyeglass frames having ear engaging extensions hingedly attached thereto such that said eyeglass frames may be flipped up with respect to said ear engaging extensions, said eyeglass frames having side by side lens areas; and,
binoculars having separate barrels attached to respective lens areas, such that said scene may be viewed without magnification with said binoculars in the flipped up position and such that a magnified portion of said scene may be viewed when said binoculars are in the flipped down position adjacent the eyes of said individual.

5. The apparatus of claim 1, wherein said ear engaging extensions include a nose contacting portion and wherein said eyeglass frames are hinged at said nose contacting position.

6. The apparatus of claim 1, wherein said lens areas each include a lens and wherein said binocular barrels are embedded in respective lenses.

7. The apparatus of claim 6, wherein said lenses are opaque at areas surrounding the associated binocular barrel.

8. The apparatus of claim 6, wherein said lenses are transparent at areas surrounding the associated binocular barrel.

9. The apparatus of claim 4, wherein said binoculars are focused at infinity.

10. The apparatus of claim 9, and further including focusing means at said binoculars for adjusting the focus of said binoculars to bring far objects into focus for said individual.

11. The apparatus of claim 10, wherein said focusing means includes knurled rings at respective barrels of said binoculars.

12. Head-mountable binoculars, comprising:
an eyeglass frame having flip up lenses; and,
binoculars mounted to said lenses such that scenes viewed by an individual wearing said binoculars can be effectively magnified when said binoculars are flipped down.

13. The binoculars of claim 12 wherein said binoculars are focused at infinity.
